(19) United States
(12) Patent Application Publication
(10) Pub. No.: US 2026/0086794 A1
(43) Pub. Date: Mar. 26, 2026

(54) VEHICLE CONTROL APPARATUS AND METHOD

(71) Applicants: HYUNDAI MOTOR COMPANY, Seoul (KR); KIA CORPORATION, Seoul (KR)

(72) Inventors: Hyeok Sang Jeong, Hwaseong-si (KR); Hae Yun Kwon, Hwaseong-si (KR); Jae Am Seo, Hwaseong-si (KR); Myeong Gyu Jeong, Hwaseong-si (KR); Jun Young Jang, Hwaseong-si (KR); In Jun Ko, Hwaseong-si (KR); Ju Ho Choi, Hwaseong-si (KR); Jae Hun Lee, Hwaseong-si (KR); Kyeong Min Kim, Hwaseong-si (KR); Yong Joon Lee, Hwaseong-si (KR); Hyun Myung Lee, Hwaseong-si (KR); Tae Young Yu, Hwaseong-si (KR); Young Sin Choi, Hwaseong-si (KR)

(73) Assignees: HYUNDAI MOTOR COMPANY, Seoul (KR); KIA CORPORATION, Seoul (KR)

(21) Appl. No.: 19/180,956

(22) Filed: Apr. 16, 2025

(30) Foreign Application Priority Data
Sep. 26, 2024 (KR) 10-2024-0131019

(51) Int. Cl. G06F 8/65; H04W 4/40

(52) U.S. Cl. CPC G06F 8/65; H04W 4/40

(57) ABSTRACT

A vehicle control apparatus includes a management control unit configured to manage OTA updates. The vehicle control apparatus also includes at least one target controller associated with the management control unit. The management control unit is configured to control the at least one target controller to maintain an alive state while performing an update.

### CROSS-REFERENCE TO RELATED APPLICATION

This application claims the benefit of and priority to Korean Patent Application No. 10-2024-0131019, filed on Sep. 26, 2024, the entire contents of which are hereby incorporated herein by reference.

### TECHNICAL FIELD

The present disclosure relates to a vehicle control apparatus and method for an over-the-air (OTA) update.

### BACKGROUND

Recently, an automotive open system architecture (AUTOSAR) platform, which is an international standard applied to effectively perform necessary high-load operation processing depending on a change in vehicle architecture and improve development convenience, has been applied to a control unit for vehicle.

AUTOSAR is a global development partnership in automobile-related fields. AUTOSAR was established in 2003 and aims to develop an open standard software structure of a vehicle electric control unit (ECU).

The AUTOSAR platform may be divided into a classic platform (CP) that uses a micro control unit (MCU) optimized for cost satisfying real-time requirements and an adaptive platform (AP) implemented based on a high-performance processor.

The CP is OSEK-based embedded real-time ECU standard, that distinguishes three software layers executed in a microcontroller, for example, an application program, a runtime environment (RTE), and back software (BSW), in the highest level of abstraction. An application software layer is mainly independent of hardware. Communication between software components and access to the BSW occur via the RTE indicating the entire interface of the application program.

The AP executes a specific function for vehicle control using an adaptive application (AA) for AP. Because the AA applies a service oriented architecture (SoA) to facilitate distributed development, software reusability and stability may be improved. As an example, the AA may include various applications for supporting a software update service, an autonomous driving service, an electric vehicle service, a connection service, and/or the like. The AP typically uses high-performance computer hardware, such as GPUs for interworking with a cloud server or use of a microprocessor and parallel processing.

Over-the-air (OTA) is a technology for wirelessly receiving firmware and/or application software from an external server while a vehicle is driving and updating control unit(s) in the vehicle.

Recently, a vehicle system with a control unit in which the CP and the AP are configured in an integrated manner has been developed.

The statements in this Background section merely provide background information related to the present disclosure and may not constitute prior art.

### SUMMARY

The present disclosure has been made to solve the above-mentioned problems occurring in the prior art while advantages achieved by the prior art are maintained intact.

Aspects of the present disclosure provide a vehicle control apparatus and method for an OTA update.

Other aspects of the present disclosure provide a vehicle control apparatus and method for allowing a management control unit to maintain target controller (s) in an alive state upon an OTA update and efficiently controlling a version combination between the management control unit and the target controller(s).

Other aspects of the present disclosure provides a vehicle control apparatus and method for adaptively performing rollback of a management control unit and/or a target controller depending on the result of updating the control unit.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control apparatus is provided. The vehicle control apparatus includes a management control unit configured to manage an over-the-air (OTA) update and at least one target controller associated with the management control unit. The management control unit is configured to control the at least one target controller to maintain an alive state while performing an update.

In an embodiment, the management control unit may include an adaptive platform (AP) and a classic platform (CP) including a micro control unit (MCU). The AP may include a wireless communication control module configured to interwork with an OTA server to receive update target software via a wireless network while driving and an update management module configured to transmit the received update target software to the at least one target controller in the alive state via the MCU and perform an update on the at least one target controller.

In an embodiment, the update management module may be configured to initiate a pre-procedure for transitioning a diagnostic session to an extended mode based on determining that a vehicle transitions to an ignition-off state. The pre-procedure may be a procedure in which a first diagnostic message for maintaining the diagnostic session and a second control message for prohibiting transmission of a general message and a network management (NM) message are transmitted to the at least one target controller via the MCU by the update management module.

In an embodiment, an update procedure for the at least one target controller may be initiated based on determining that the pre-procedure is completed. An update procedure for the management control unit may be performed based on determining that the update on the at least one target controller succeeds and rollback for the at least one target controller may be performed based on determining that the update on the at least one target controller fails.

In an embodiment, the update management module may be configured to transition the diagnostic session to a default mode based on determining that an update on the management control unit succeeds and the management control unit and the at least one target controller may transition to a sleep state.

In an embodiment, the management control unit and the target controller may be rolled back after the pre-procedure is performed based on determining that an update on the management control unit fails.

In an embodiment, the update management module may be configured to transmit a third control message to the at least one target controller via the MCU based on determining that the update on the at least one target controller succeeds to release the prohibition of the transmission of the general message and the NM message. the update management module may also be configured to transmit a first NM message including a reset partial network cluster (PNC) value to the at least one target controller via the MCU.

In an embodiment, the update management module may be configured to set a self-update mode after transmitting the first NM message. The management control unit may be reset based on determining that the self-update mode is set and an update procedure for the management control unit may be initiated.

In an embodiment, the MCU may be configured to store the reset PNC value. The MCU may be configured to periodically transmit a second NM message including the stored PNC value to the at least one target controller based on booting of the MCU is completed as the management control unit is reset.

In an embodiment, the management control unit is configured to, while the update is being performed, periodically transmit a message to the at least one target controller to prevent the at least one target controller from entering a sleep state.

According to another aspect of the present disclosure, a method in a vehicle control apparatus interworking with an over-the-air (OTA) server via a wireless network is provided. The method includes controlling, by a management control unit included in the vehicle control apparatus to manage an OTA update, at least one target controller associated with the management control unit to maintain an alive state while performing an update.

In an embodiment, the management control unit may include an adaptive platform (AP) and a classic platform (CP) including a micro control unit (MCU). The method may further include receiving, by the AP, update target software from the OTA server while driving and transmitting, by the AP, the received update target software to the at least one target controller in the alive state via the MCU.

In an embodiment, the method may further include performing, by the AP, a pre-procedure for transitioning a diagnostic session to an extended mode based on determining that a vehicle transitions to an ignition-off state. The pre-procedure may include transmitting a first diagnostic message for maintaining the diagnostic session and a second control message for prohibiting transmission of a general message and a network management (NM) message to the at least one target controller via the MCU.

In an embodiment, the method may further include initiating an update procedure for the at least one target controller based on determining that the pre-procedure is completed. An update procedure for the management control unit may be performed based on determining that an update on the at least one target controller succeeds and rollback for the at least one target controller may be performed based on determining that the update on the at least one target controller fails.

In an embodiment, the method may further include transitioning, by the update management module, the diagnostic session to a default mode based on an update on the management control unit succeeds and transitioning, by the management control unit and the at least one target controller, to a sleep state.

In an embodiment, the management control unit and the target controller may be rolled back after the pre-procedure is performed based on determining that an update on the management control unit fails.

In an embodiment, the method may further include transmitting, by the AP, a third control message for releasing the prohibition of the transmission of the general message and the NM message to the at least one target controller via the MCU based on determining that an update on the at least one target controller succeeds, resetting, by the AP, a reset partial network cluster (PNC) value, and transmitting, by the AP, a first NM message including the reset PNC value to the at least one target controller via the MCU.

In an embodiment, the method may further include setting, by the AP, a self-update mode after transmitting the first NM message. The method may also include resetting the management control unit based on determining that the self-update mode is set and an update procedure for the management control unit is initiated.

In an embodiment, the method may further include storing, by the MCU, the reset PNC value based on determining that the first NM message is received. The MCU may periodically transmit a second NM message including the stored PNC value to the at least one target controller based on determining that booting of the MCU is completed as the management control unit is reset.

In an embodiment, method further includes, while the update is being performed, periodically transmitting, by the management control unit, a message to the at least one target controller to prevent the at least one target controller from entering a sleep state.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a configuration diagram of a system according to an embodiment of the present disclosure;

FIG. 2 is a block diagram for describing a configuration and operation of a management control unit according to an embodiment of the present disclosure;

FIG. 3 is a flowchart for describing operation of an OTA server according to an embodiment of the present disclosure;

FIG. 4 is a flowchart for describing operation of a vehicle for an OTA update according to an embodiment of the present disclosure;

FIG. 5 is a flowchart for describing a software update procedure of a management control unit according to an embodiment of the present disclosure;

FIG. 6 is a flowchart for describing a procedure of updating management control unit software according to an embodiment of the present disclosure;

FIG. 7 is a flowchart for describing an OTA update procedure in a vehicle according to an embodiment of the present disclosure; and

FIG. 8 illustrates a computing system according to an embodiment of the present disclosure.

### DETAILED DESCRIPTION

Hereinafter, embodiments of the present disclosure are described in detail with reference to the accompanying drawings. In adding the reference numerals to the components of each drawing, it should be noted that the identical components are designated by the identical numerals even when the components are displayed on different drawings. Further, in describing the embodiment of the present disclosure, a detailed description of well-known features or functions as been omitted where it was determined that the detailed description would unnecessarily obscure the gist of the present disclosure.

In describing the components of the embodiment according to the present disclosure, terms such as first, second, “A”, “B”, (a), (b), and the like may be used. These terms are merely intended to distinguish one component from another component. The terms do not limit the nature, sequence, or order of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art. The terms should not be interpreted as having ideal or excessively formal meanings unless clearly defined as having such in the present disclosure.

When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each component, module controller, device, element, apparatus, and the like may separately embody or be included with a processor and a memory, such as a non-transitory computer readable media, as part of the apparatus.

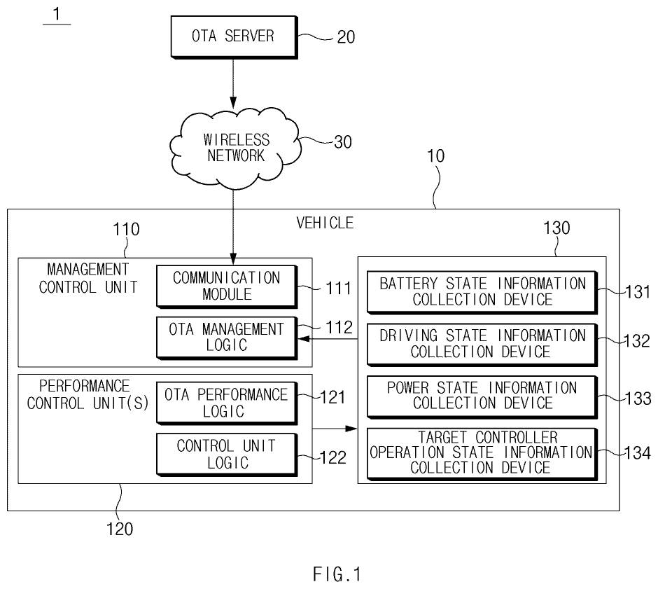

Hereinafter, embodiments of the present disclosure are described in detail with reference to FIGS. 1-8.

FIG. 1 is a configuration diagram of a system according to an embodiment of the present disclosure.

Referring to FIG. 1, a system 1 may include a vehicle 10, an OTA server 20, and a wireless network 30.

In an embodiment, the wireless network 30 may include a dedicated vehicle wireless communication network, such as WAVE. However, the present disclosure is not limited thereto. For example, the wireless network 30 according to another embodiment may include a mobile communication network constructed according to technology standards for mobile communication, for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), 5G new radio (5G NR), or the like.

The vehicle 10 may include a management control unit 110, at least one target controller 120, and a vehicle state information collector 130.

The management control unit 110 may include a communication module 111 for performing communication with the OTA server 20 and OTA management logic 112 for collecting various pieces of vehicle state information from the vehicle state information collector 10 and controlling and managing an OTA update. The vehicle state information may include, but is not limited to, battery state information, driving state information, power state information, target controller operation state information, and/or the like.

The communication module 111 according to an embodiment may support wireless-fidelity (Wi-Fi), Bluetooth, Wi-Fi Direct, and/or the like.

The communication module 111 according to an embodiment may include an identification module (not shown). As an example, the identification module may be a chip for storing information for identifying the vehicle 10, for example, various pieces of information for authenticating access authority of telematics communication, such as a manufacturer, a vehicle type, an area, a vehicle identification number (VIN), and the like, that may include a user identify module (UIM), a subscriber identify module (SIM), a universal subscriber identify module (USIM), and/or the like. In some embodiments, a device including the identification module may be implemented with a smart card or the like to be connected with the communication module 111 via a separate port.

The target controller(s) 120 may include OTA performance logic 121 for performing an OTA update under control of the OTA management logic 112 of the management control unit 110 and control unit logic 122 for controlling a corresponding control unit using firmware updated by the OTA performance logic 121.

The vehicle state information collector 130 may collect vehicle state information from the target controller(s) 120. As an example, the vehicle state information collector 130 may include a battery state information collection device 131 for collecting battery state information, a driving state information collection device 132 for collecting current driving state information of the vehicle 10, a power state information collection device 133 for collecting power state information of the vehicle 10, and a target controller operation state information collection device 134 for collecting target controller operation state information.

The OTA server 20 may interwork with the vehicle 10 via the wireless network 30 to control software for each control unit in the vehicle 10 to be updated.

A control unit wireless update or over-the-air (OTA) is a technology for the vehicle and the provided management control unit 110 to receive firmware via the wireless network 30 from the OTA server 20 and update the target controller(s) 120.

For the OTA update according to embodiments of the present disclosure, even the management control unit 110 may be an update target. Because the target controller(s) 120 that has(have) a correlation or dependency on the management control unit 110 should control a version combination, the target controller(s) 120 may be updated by the management control unit 110. Furthermore, there may occur a situation of rolling back the target controller(s) 120, the update of which is already completed according to the update result of the management control unit 110, to a previous version. Embodiments of the present disclosure may provide a method for maintaining the target controller(s) 120 in an alive state, when performing an update on the management control unit 110.

The management control unit 110 according to an embodiment may periodically transmit an NM message or a diagnosis message to the target controller(s) 120 while performing an update to maintain the target controller(s) 120 in the alive state to prevent the target controller(s) 120 that is(are) in the alive state to enter a sleep state if a reset is generated while performing an update.

According to the above characteristics, embodiments of the present disclosure may be different from a conventional scheme for compulsorily waking up the target controller(s) 120 that is(are) in the sleep state and transitioning to the alive state. Embodiments of the present disclosure have an advantage in which a separate hardware (H/W) change for waking up a separate control unit, for example, transceiver addition or the like, is not required.

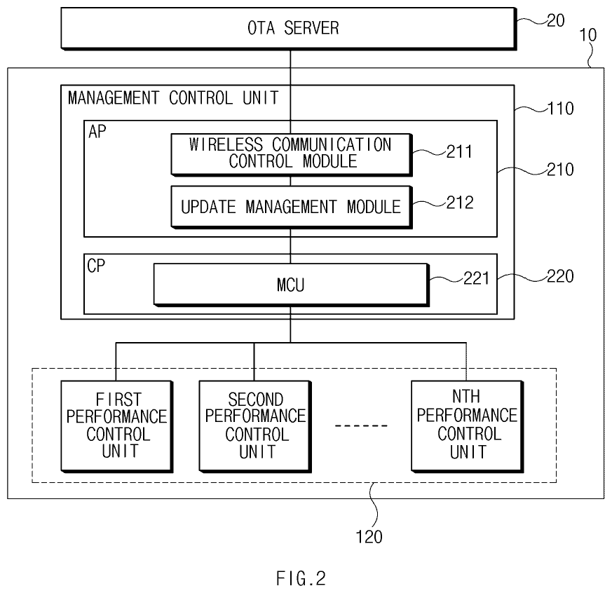

FIG. 2 is a block diagram for describing configuration and operation of a management control unit according to another embodiment of the present disclosure.

Referring to FIG. 2, a vehicle 10 may include a management control unit 110 and first to Nth target controllers 120.

The vehicle 10 may download new firmware and/or application software of control unit(s) in the vehicle 10 from an OTA server 20 via a wireless network 30 and may perform an update.

The management control unit 110 may include an adaptive platform (AP) 210 and a classic platform (CP) 220.

In an embodiment, the AP 210 may be implemented with a high-performance processor (or a high-performance computer) and may include a wireless communication control module 211 and an update management module 212.

The CP 220 may be run and controlled by the AP 210 and may include a micro control unit (MCU) 221.

The management control unit 110 may include an operating system (not shown) running on a processor. The AP 210 and an adaptive application (AA) may be driven on the operating system and the AA for performing a specific function of a control system for vehicle on the AP 210 may be loaded into the management control unit 110. The management control unit 110 may include a manager AA (not shown) that connects the AP 210 and the AA.

The operating system may physically and logically divide a hardware layer represented as a processor and a software layer configured in response to the manager AA.

The AP 210 may provide a function for supporting application execution by high-performance hardware, supporting various audio and video drives, and supporting an interface and a vehicle communication network capable of being connected with an external device, for example, the OTA server 20.

The APP executed on the AP 210 may be built for each application and independent execution of the AA may be ensured.

The manager AA may provide a function for managing communication between one application and another application, a function for managing execution of each application, and a function for collecting and managing vehicle state information. The manager AA may communicate with the AP 210 using an application programming interface (API) and may transmit and receive information with each application in a scalable service-oriented middleware over IP (SOME/IP) scheme.

The OTA server 20 may receive version and vehicle information of each of pieces of software, for example, a manufacturer, a vehicle type, an area, a VIN, and/or the like, from the management control unit 110. The OTA server 20 may determine a current event version of the vehicle 10. The OTA server 20 may specify a target event version based on the current event version. The OTA server 20 may control software for being updated to the target event version to be downloaded by the management control unit 110 of the vehicle 10.

The management control unit 110 may be a control unit for managing an OTA update, that may download corresponding software from the OTA server 20 while driving and may transmit the software to the target controller(s) 120 to execute reprogramming.

The wireless communication control module 211 of the management control unit 110 may transmit a certain message including update state information including current version information of control units mounted in the vehicle 10 to the OTA server 20 to download software, for example, read only memory (ROM) data from the OTA server 20 and may receive an update command including new version information from the OTA server 20.

The update management module 212 of the management control unit 110 may play a role in managing update execution and configuring a diagnostic message for the update execution (hereinafter used interchangeably with “unified diagnostic service (UDS) message”) and a network management (NM) message depending on a predefined procedure. The diagnostic message and the NM message transmitted from the update management module 212 may be received in the MCU 221 of the CP 220. The MCU 221 may transmit the received diagnostic message and the received NM message to corresponding target controller(s) 120 via a physical channel. As an example, the physical channel may include, but is not limited to, a controller area network (CAN) communication channel, an Ethernet communication channel, a Flexlay channel, and/or the like.

The target controller(s) 120 may receive ROM data by means of the diagnostic message generated by the update management module 212 of the AP 210 and received via the MCU 221 of the CP 220 to perform reprogramming and may maintain its alive state by means of the specific diagnostic message and the specific NM message.

The process of updating a control unit may be composed of a “process” process and an activation process (hereinafter referred to as an “activate” process).

The “process” process may be a process of writing a binary corresponding to a new version in a bootable memory area of a corresponding target controller.

The activate process may be a process of setting a boot flag, resetting a corresponding target controller, and checking a version to check whether an update succeeds.

Herein, the setting of the boot flag may vary with a type of the control unit. As an example, a default control unit may always operate in a boot loader before deleting an existing boot flag when starting the “process” process and setting the boot flag again. On the other hand, a memory duplex control unit may set whether to boot to any of area A and area B which are duplicated in the activate process.

In the past, there was a problem of not maintaining an alive state of target controller(s) until a time point when the booting of a management control unit is completed if the management control unit is reset in the activate process of the management control unit.

The management control unit 110 according to an embodiment of the present disclosure may be configured in the form of integrating the AP 210 and the MCU 221 of the CP 220 and may be implemented such that the MCU 221 periodically transmits a certain diagnostic message and/or a certain NM message to maintain the target controller(s) 120 in the alive state upon an update.

A time taken until the booting of the AP 210 is completed may be greater than a time taken until the booting of the MCU 221 is completed. As an example, it may take 10 seconds or more for the AP 210 and it may take several msec for the MCU 221.

The update management module 212 according to an embodiment may determine timing when the reset of the management control unit 110 will occur and may control the MCU 221 to transmit the NM message and/or the diagnostic message for maintaining the alive state of the target controller(s) 120 in advance before the reset.

As an example, the update management module 212 may determine that the reset will occur based on determining that there is previously downloaded new software and that the vehicle 10 is ignition off.

The update management module 212 may perform a function of setting an update mode of the management control unit 110, a function of setting a partial network cluster (PNC), and a function of configuring an NM message depending on the set PNC. Herein, the PNC may be information included in an AUTOSAR NM message, which refers to mapping a logical network cluster, for example, defining (or binding) the management control unit 110 and a first target controller as a network cluster to a specific bit on the NM message. In other words, as shown in Table 1 below, a control unit included in a target cluster may check and identify the specific bit of the NM message and may perform network state transition by means of the specific bit.

TABLE 1

| | | | | | | | |
|---|---|---|---|---|---|---|---|
| 8 | 7 | 6 | 5 | 4 | 3 | #2 bit | #1 bit |

| | | | | | |
|---|---|---|---|---|---|
| . . . | . . . | . . . | CCU, Control unit C | CCU, Control unit B | CCU, Control unit A |
| . . . | | | | | |

The update management module 212 may monitor the update result of the management control unit 110 to determine whether normal completion is performed and may execute rollback of the management control unit 110 and/or the target controller(s) 120 or may end the update process, depending on the determined result.

The MCU 221 may store a PNC value included in the NM message based on determining that the management control unit 110 enters a self-update mode and may generate and transmit an NM message to the target controller(s) 120 depending on the PNC value that is stored before the management control unit 110 is reset before the command from the AP 210 is received from the management control unit 110 is reset.

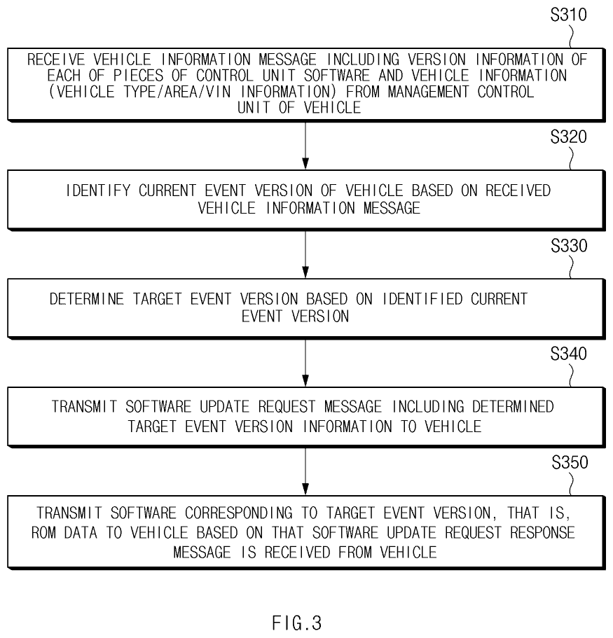

FIG. 3 is a flowchart for describing operation of an OTA server according to an embodiment of the present disclosure.

Referring to FIG. 3, in an operation S310, an OTA server 20 may receive a vehicle information message including version information of each of pieces of control unit software and vehicle information from a management control unit 110 of a vehicle 10. As an example, the vehicle information may include vehicle type information, area information, a vehicle identification number (VIN), and/or the like.

In an operation S320, the OTA server 20 may identify a current event version of the vehicle 10 based on the received vehicle information message.

In an operation S330, the OTA server 20 may determine a target event version based on the identified current event version.

In an operation S340, the OTA server 20 may transmit a software update request message including the determined target event version information to the vehicle 10.

In an operation S350, the OTA server 20 may transmit software corresponding to the target event version, e.g., ROM data, to the vehicle 10 based on determining that a software update request response message is received from the vehicle 10.

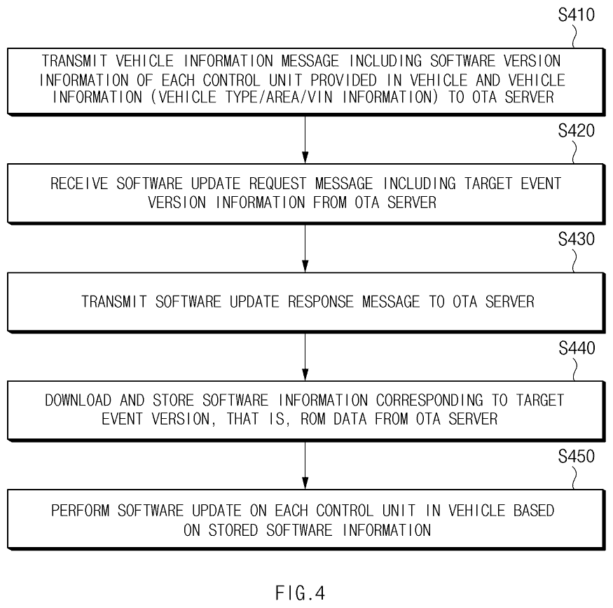

FIG. 4 is a flowchart for describing operation of a vehicle for an OTA update according to an embodiment of the present disclosure.

Referring to FIG. 4, in an operation S410, a vehicle 10 may transmit a vehicle information message including software version information of each control unit provided therein and vehicle information to an OTA server 20.

In an operation S420, the vehicle 10 may receive a software update request message including target event version information from the OTA server 20.

In an operation S430, the vehicle 10 may transmit a software update response message to the OTA server 20.

In an operation S440, the vehicle 10 may download software information corresponding to a target event version, that is, ROM data from the OTA server 20 and may store the software information in a certain write area.

In an operation S450, the vehicle 10 may perform a software update on each control unit in the vehicle 10 based on the stored software information. Herein, the software update procedure for each control unit should be more clearly understood by those having ordinary skill in the art to which the present disclosure pertains flow the following description with reference to the accompanying drawings.

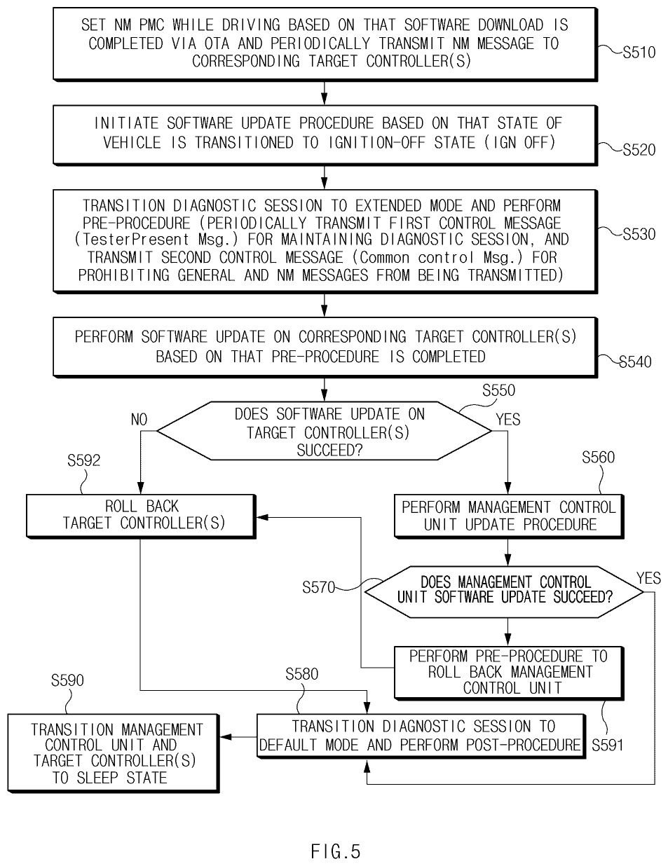

FIG. 5 is a flowchart for describing a software update procedure of a management control unit according to an embodiment of the present disclosure.

In detail, FIG. 5 is a flowchart for describing a procedure in which a management control unit 110 updates software of target controller(s) 120, including itself.

Referring to FIG. 5, in an operation S510, the management control unit 110 may set an NM PMC while driving based on determining that software download is completed via OTA and may periodically transmit an NM message to corresponding target controller(s). Herein, if the software download via OTA is normally completed, the management control unit 110 may determine that software update preparation for the target controller(s) 120 is completed.

In an operation S520, the management control unit 110 may initiate a software update procedure based on determining that the state of the vehicle 10 transitions to an ignition-off state (IGN Off). As an example, if the state of the vehicle 10 transitions from a driving state or a stop state to the ignition-off state, the management control unit 110 may initiate the software update procedure.

In an operation S530, the management control unit 110 may transition a diagnostic session from a default mode to an extended mode and may perform a pre-procedure. In an embodiment, the pre-procedure may include a procedure for periodically transmitting a first control message for maintaining a diagnostic session, for example, TesterPresent Msg., and a procedure for transmitting a second control message for prohibiting transmission of general and NM message, for example, Common control Msg.

In an operation S540, the management control unit 110 may perform a software update on corresponding target controller(s) 120 based on determining that the pre-procedure is completed.

In an operation S550, the management control unit 110 may determine whether the software update on the target controller(s) 120 is normally completed.

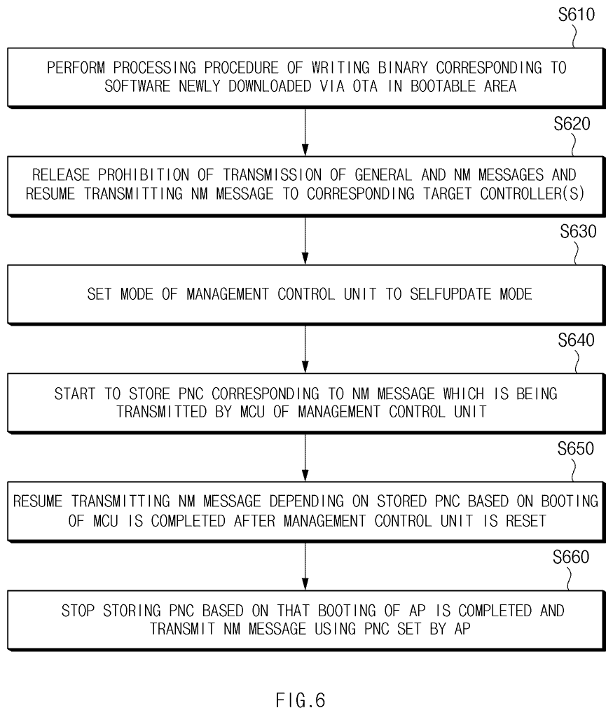

As a result of the determination in the operation S550, if the software update is normally completed, the management control unit 110 may perform its own update procedure. A more detailed operation in which the management control unit 110 updates its own software, according to an embodiment, is provided below with reference to FIG. 6.

In an operation S570, the management control unit 110 may determine whether its own software update is normally completed.

As a result of the determination in the operation S570, if the software update is normally completed, in an operation S580, the management control unit 110 may transition the diagnostic session from the extended mode to the default mode and may perform a post-procedure. The post-procedure according to an embodiment may include a procedure of releasing prohibition of transmission of general and NM messages, a procedure of transitioning the diagnostic session to the default mode, and a procedure of initializing a PNC.

If the post-procedure is completed, in an operation S590, the management control unit 110 may transition itself and the target controller(s) 120 to a sleep state and may end the software update procedure.

As a result of the determination in the operation S570, if the software update is not normally completed, in operations S591 and S592, the management control unit 110 may perform the pre-procedure to roll back itself to a previous software version and may roll back the target controller(s) 120.

As a result of the determination in the operations S550, if the software update on the target controller(s) 120 fails, the management control unit 110 may roll back a software version of the target controller(s) 120 to a previous version and may enter S580 described above. As an example, the management control unit 110 may roll back the target controller(s) 120 which has dependency on itself.

FIG. 6 is a flowchart for describing a procedure of updating management control unit software according to an embodiment of the present disclosure.

In detail, FIG. 6 is a drawing for describing a detailed procedure of the operation S560 of FIG. 5, according to an embodiment.

Referring to FIG. 6, in an operation S610, a management control unit 110 may perform a processing procedure of writing a binary (or a binary code) corresponding to software newly downloaded via OTA in a bootable area.

In an operation S620, the management control unit 110 may release prohibition of transmission of general and NM messages and may resume transmitting an NM message to corresponding target controller(s) 120. Herein, the NM message may be periodically transmitted by an MCU 221.

In an operation S630, the management control unit 110 may set its own mode to a self-update mode. Herein, the self-update mode may refer to a mode in which the management control unit 110 updates software for itself.

In an operation S640, the management control unit 110 may start to store a PNC corresponding to the NM message which is being transmitted by the MCU 221.

In an operation S650, the management control unit 110 may resume transmitting the NM message depending on the stored PNC based on the booting of the MCU 221 is completed after being reset. Because a booting time of the MCU 221 is greater than a booting time of an AP 210, transmission of the NM message may be resumed before a timer of the NM message expires, that is, before an NM timeout. As a result, the target controller(s) 120 may maintain an active state without entering a sleep state even while the software of the management control unit 110 is updated.

In an operation S660, the management control unit 110 may stop storing the PNC based on determining that the booting of the AP 210 is completed and may transmit an NM message using the PNC set by the AP 210.

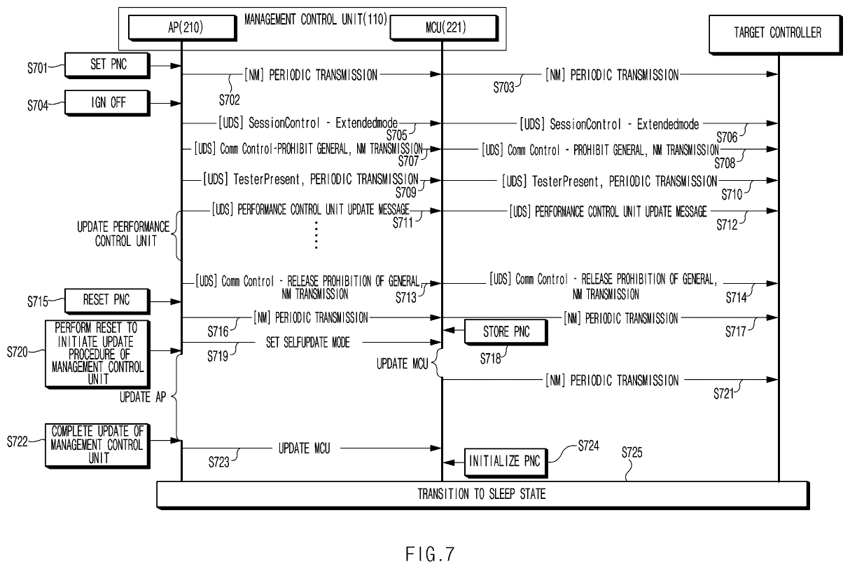

FIG. 7 is a flowchart for describing an OTA update procedure in a vehicle according to an embodiment of the present disclosure.

Referring to FIG. 7, in an operation S701, an AP 210 may identify a target controller to maintain an alive state and may set a PNC corresponding to the identified target controller.

In operations S702 and S703, the AP 210 may periodically transmit an NM message including the set PNC value to target controller(s) 120 via an MCU 220.

In operations S704-S706, the AP 210 may transmit a certain diagnostic message for instructing to switch to an extended mode, for example, a SessionControl message to the target controller(s) 120 via the MCU 221 based on transitioning to vehicle ignition-off (IGN OFF).

In operations S707 and 5708, the AP 210 may transmit a certain diagnostic message for prohibiting transmission of general and NM messages, for example, a communication control message to the target controller(s) 120 via the MCU 221.

In operations S709 and S710, the AP 210 may transmit a certain diagnostic message for maintaining the target controller(s) 120 in the alive state, for example, a TesterPresent message to the target controller(s) 120 via the MCU 221.

Via operations S707 to S710, the management control unit 110 may block transmission of the general and NM message to occupy a CAN bus for the purpose of ensuring reprogramming performance and the target controller(s) 120 may maintain a diagnostic session based on the received TesterPresent message to maintain the alive state.

In operations S711 and S712, the AP 210 may transmit an update message including ROM data to the update target controller(s) 120 via the MCU 221 and may perform an update on the corresponding target controller(s) 120.

In operations S713 and S714, the AP 210 may transmit a diagnostic message for releasing the prohibition of the transmission of the general and NM messages, that is, a communication control message to the target controller(s) 120 via the MCU 221 based on determining that the update of the target controller (s) 120 is normally completed.

In operations S715-S717, the AP 210 may reflect the update of the target controller (s) 120 to reset the PNC and may periodically transmit an NM message including the reset PNC value to the corresponding target controller(s) 120 via the MCU 221.

In an operation S718, the MCU 221 may store the PNC value included in the NM message received in S716.

In operations S719 and S720, the AP 210 may transmit a certain message for providing a notification that it switches to the self-update mode to the MCU 221 and may automatically perform a reset to initiate an update procedure of the management control unit 110.

Because it takes a longer booting time of the AP 210 than the booting time of the MCU 221, the booting of the MCU 221 may be first completed. In this case, in the operation S720, the MCU 221 may generate an NM message using the PNC value stored in the operation S718 and may periodically transmit the generated NM message to the target controller(s) 120. In this case, the target controller(s) 120 may maintain an alive state regardless of whether the management control unit 110 is reset.

In operations S722 and S723, the AP 210 may transmit a certain control message for setting a default mode to the MCU 221 based on the update of the management control unit 110 is completed.

In an operation S724, the MCU 221 may initialize the PNC when a control message for setting an existing mode is received.

In an operation S725, the management control unit 110 and the target controller(s) 120 may transition to a sleep state to end the update procedure.

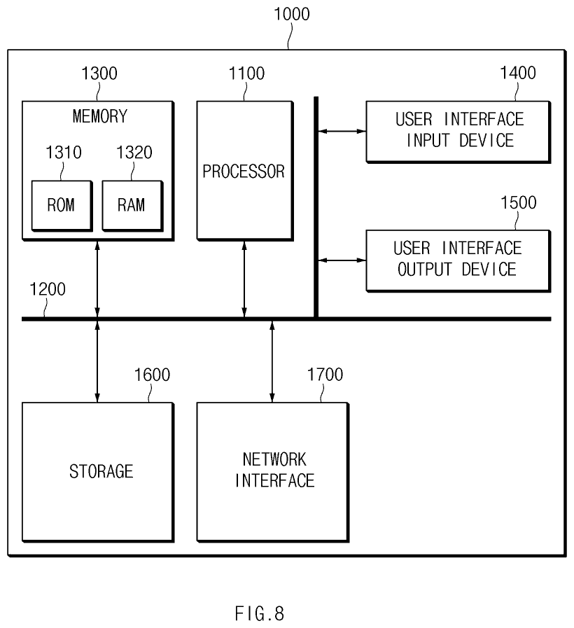

FIG. 8 illustrates a computing system according to an embodiment of the present disclosure.

Referring to FIG. 8, a computing system 800 may include at least one processor 820, a memory 830, a user interface input device 840, a user interface output device 850, a storage 860, and a network interface 870, which are connected with each other via a bus 810.

The processor 820 may be a central processing unit (CPU) or a semiconductor device that processes instructions stored in the memory 830 and/or the storage 860. The memory 830 and the storage 860 may include various types of volatile or non-volatile storage media. For example, the memory 830 may include a ROM (Read Only Memory) 831 and a RAM (Random Access Memory) 832.

Thus, the operations of the method or the algorithm described in connection with the embodiments disclosed herein may be embodied directly in hardware or a software module executed by the processor 820, or in a combination thereof. The software module may reside on a storage medium (that is, the memory 830 and/or the storage 860) such as a RAM, a flash memory, a ROM, an EPROM, an EEPROM, a register, a hard disc, a removable disk, and a CD-ROM. For example, the processor 820 may correspond to the processor 110 described above.

The storage medium may be coupled to the processor 820. The processor 820 may read out information from the storage medium and may write information in the storage medium. Alternatively, the storage medium may be integrated with the processor 820. The processor and the storage medium may reside in an application specific integrated circuit (ASIC). The ASIC may reside in the control unit in the vehicle. Alternatively, the processor 820 and storage medium may reside as separate components in the vehicle control unit.

Embodiments of the present disclosure may provide the vehicle control apparatus for the OTA update and the method thereof.

Furthermore, embodiments of the present disclosure may provide the vehicle control apparatus capable of allowing a management control unit to maintain target controller(s) in an alive state upon an OTA update and efficiently controlling a version combination between the management control unit and the target controller(s) and the method thereof.

Furthermore, embodiments of the present disclosure may adaptively control rollback of the management control unit and/or the target controller depending on the result of updating the control unit, thus efficiently controlling a version combination of target controller(s) which has (have) a correlation with the management control unit.

Furthermore, embodiments of the present disclosure may perform control for preventing sleep of the target controller after ignition-off (IGN off) without a change in hardware (HW) in a vehicle to which a SelectiveWakeup function is not applied, thus stably performing the whole update process and the whole update scenario, for example, rollback after update success or update failure, or the like.

Furthermore, the present technology may minimize message transmission during an update, thus optimizing performance of reprogramming the target controller.

In addition, various effects ascertained directly or indirectly through the present disclosure may be provided.

Hereinabove, although the present disclosure has been described with reference to example embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

Accordingly, embodiments of the present disclosure are intended not to limit but to explain the technical idea of the present disclosure, and the scope and spirit of the present disclosure is not limited by the above embodiments. The scope of the present disclosure should be construed on the basis of the accompanying claims, and all the technical ideas within the scope equivalent to the claims should be included in the scope of the present disclosure.

What is claimed is:

1. A vehicle control apparatus, comprising:
a management control unit configured to manage over-the-air (OTA) updates; and
at least one target controller associated with the management control unit,
wherein the management control unit is configured to control the at least one target controller to maintain an alive state while performing an update.

2. The vehicle control apparatus of claim 1, wherein the management control unit includes an adaptive platform (AP) and a classic platform (CP) including a micro control unit (MCU), and wherein the AP includes
a wireless communication control module configured to interwork with an OTA server to receive update target software via a wireless network while driving, and
an update management module configured to transmit the received update target software to the at least one target controller in the alive state via the MCU.

3. The vehicle control apparatus of claim 2, wherein the update management module is configured to:
initiate a pre-procedure for transitioning a diagnostic session to an extended mode based on determining that a vehicle transitions to an ignition-off state; and
transmit, to the at least one target controller via the MCU, i) a first diagnostic message for maintaining the diagnostic session and ii) a second control message for prohibiting transmission of a general message and a network management (NM) message.

4. The vehicle control apparatus of claim 3, wherein the update management module is configured to:
initiate an update procedure for the at least one target controller based on determining that the pre-procedure is completed; and
perform i) an update procedure for the management control unit based on determining that the update on the at least one target controller succeeds or ii) rollback for the at least one target controller based on determining that the update on the at least one target controller fails.

5. The vehicle control apparatus of claim 3, wherein the update management module is configured to transition the diagnostic session to a default mode based on determining that i) an update on the management control unit succeeds and ii) the management control unit and the at least one target controller transition to a sleep state.

6. The vehicle control apparatus of claim 3, wherein the update management module is configured to, after the pre-procedure is performed, perform rollback for the management control unit and the at least one target controller based on determining that an update on the management control unit fails.

7. The vehicle control apparatus of claim 3, wherein the update management module is configured to:
transmit a third control message to the at least one target controller via the MCU based on determining that the update on the at least one target controller succeeds to release prohibition of the transmission of the general message and the NM message; and
transmit a first NM message including a reset partial network cluster (PNC) value to the at least one target controller via the MCU.

8. The vehicle control apparatus of claim 7, wherein the update management module is configured to:
set a self-update mode after transmitting the first NM message; and
reset the management control unit based on determining that the self-update mode is set and an update procedure for the management control unit is initiated.

9. The vehicle control apparatus of claim 8, wherein the MCU is configured to:
store the reset PNC value; and
periodically transmit a second NM message including the reset PNC value to the at least one target controller based on determining that booting of the MCU is completed as the management control unit is reset.

10. The vehicle control apparatus of claim 1, wherein the management control unit is configured to, while the update is being performed, periodically transmit a message to the at least one target controller to prevent the at least one target controller from entering a sleep state.

11. A method in a vehicle control apparatus interworking with an over-the-air (OTA) server via a wireless network, the method comprising:
controlling, by a management control unit included in the vehicle control apparatus, at least one target controller associated with the management control unit to maintain an alive state while performing an update.

12. The method of claim 11, wherein:
the management control unit includes an adaptive platform (AP) and a classic platform (CP) including a micro control unit (MCU); and
the method further comprises
receiving, by the AP, update target software from the OTA server while driving, and
transmitting, by the AP, the update target software to the at least one target controller in the alive state via the MCU.

13. The method of claim 12, further comprising performing, by the AP, a pre-procedure for transitioning a diagnostic session to an extended mode based on determining that a vehicle transitions to an ignition-off state,
wherein performing the pre-procedure includes transmitting a first diagnostic message for maintaining the diagnostic session and a second control message for prohibiting transmission of a general message and a network management (NM) message to the at least one target controller via the MCU.

14. The method of claim 13, further comprising:
initiating an update procedure for the at least one target controller based on determining that the pre-procedure is completed, and
performing i) an update procedure for the management control unit based on determining that an update on the at least one target controller succeeds or ii) rollback for the at least one target controller based on determining that the update on the at least one target controller fails.

15. The method of claim 13, further comprising:
transitioning, by the AP, the diagnostic session to a default mode based on determining that an update on the management control unit succeeds; and
transitioning, by the AP, the management control unit and the at least one target controller to a sleep state.

16. The method of claim 13, further comprising, after the pre-procedure is performed, rolling back the management control unit and the target controller based on determining that an update on the management control unit fails.

17. The method of claim 13, further comprising:
transmitting, by the AP, a third control message for releasing prohibition of the transmission of the general message and the NM message to the at least one target controller via the MCU based on determining that an update on the at least one target controller succeeds;
resetting, by the AP, a reset partial network cluster (PNC) value; and
transmitting, by the AP, a first NM message including the reset PNC value to the at least one target controller via the MCU.

18. The method of claim 17, further comprising:
setting, by the AP, a self-update mode after transmitting the first NM message; and
resetting the management control unit based on determining that the self-update mode is set and an update procedure for the management control unit is initiated.

19. The method of claim 18, further comprising:
storing, by the MCU, the reset PNC value in response to receiving the first NM message; and
periodically transmitting, by the MCU, a second NM message including the reset PNC value to the at least one target controller based on determining that booting of the MCU is completed as the management control unit is reset.

20. The method of claim 11, further comprising, while the update is being performed, periodically transmitting, by the management control unit, a message to the at least one target controller to prevent the at least one target controller from entering a sleep state.
